(19) United States
(12) Patent Application Publication
(10) Pub. No.: US 2021/0374726 A1
(43) Pub. Date: Dec. 2, 2021

(54) SYSTEMS AND METHODS FOR FACILITATING NETWORK MESSAGING

(71) Applicant: MASTERCARD INTERNATIONAL INCORPORATED, Purchase, NY (US)

(72) Inventors: Ben Parkinson, London (GB); Harold Bosse, London (GB); Ian Russell, London (GB)

(21) Appl. No.: 17/336,371

(22) Filed: Jun. 2, 2021

Related U.S. Application Data
(60) Provisional application No. 63/033,732, filed on Jun. 2, 2020.

(51) Int. Cl. G06Q 20/38; G06Q 20/10; H04L 12/58; G06Q 40/04

(52) U.S. Cl. CPC G06Q 20/381; G06Q 40/04; H04L 51/10; G06Q 20/10

(57) ABSTRACT

Systems and methods are provided for facilitating network messaging. An example method includes receiving a request to transfer funds, in a first currency, from a sender institution in a first region to a beneficiary institution in a second region and verifying presence of the funds at a sponsor institution in the first region. The method also includes requesting a conversion quote from an FX provider for the funds in the first currency, receiving the conversion quote from the FX provider in a second currency, and adding an entry for the funds in the second currency to a ledger. The method further includes requesting, from a liquidity provider in the second region, a liquidity quote for the funds in the second currency, accepting the liquidity quote from the liquidity provider, and facilitating settlement between the sponsor institution in the first region, the FX provider, and the liquidity provider.

### CROSS-REFERENCE TO RELATED APPLICATION

This application claims the benefit of and priority to U.S. Provisional Application No. 63/033,732, filed Jun. 2, 2020. The entire disclosure of the above application is incorporated herein by reference.

### FIELD

The present disclosure generally relates to systems and methods for use in facilitating network messaging, and in particular, to systems and methods for use in coordinating network messaging between different regions.

### BACKGROUND

This section provides background information related to the present disclosure which is not necessarily prior art.

Entities are known to facilitate network messaging for various different purposes. Transferring funds is one such propose, in which messaging is used to indicate the transfer of the funds from one account to another account. When the transfer of funds extends between different countries, the interaction may be referred to, for example, as a cross-border transaction. In connection therewith, cross-border transactions may further involve different currencies, whereby an exchange of one currency for another is also included in the interaction. It is common for entities (e.g., banks, etc.) involved in such cross-border transactions to hold funds in different regions, for example, with partnering entities, in order to settle interactions in those regions.

### DRAWINGS

The drawings described herein are for illustrative purposes only of selected embodiments and not all possible implementations, and are not intended to limit the scope of the present disclosure.

FIG. 1 is an example system of the present disclosure suitable for use in facilitating network messaging between different regions;

FIG. 2 is an example ledger including entries for credits and debits and which may be used in the system of FIG. 1;

FIG. 3 is a block diagram of an example computing device that may be used in the system of FIG. 1;

FIG. 4 is an example method that may be implemented in the system of FIG. 1, or otherwise, for facilitating cross-border, or cross-currency, transactions;

FIG. 5 is an example ledger including entries for credits and debits, at a repository, for transactions performed in connection with the system of FIG. 1 and/or the method of FIG. 4;

FIGS. 6A-6C illustrate an example method that may be implemented in the system of FIG. 1, or otherwise, for facilitating cross-border, or cross-currency, transactions; and

FIG. 7 is another example ledger including entries for credits and debits, at a repository, for transactions performed in connection with the method of FIGS. 6A-6C.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

For cross-border transactions and/or cross-currency transactions, it is often required for institutions (e.g., banks, etc.) involved in the transactions (e.g., sender institutions, etc.) to maintain or hold funds in each of the regions implicated by the transactions (in respective currencies of the regions), in order to provide for settlement of the transactions by way of subsequent fund transfers. What's more, cross-border transactions generally include delays or lags between initiation of the underlying transactions and subsequent settlement, for example, due to the requirement for added network communications between different regions, multiple processes required to perform the transactions, limited operating hours to accommodate the transactions, differing time zones, etc., whereby beneficiary institutions may be required to initiate investigations of the fund transfers days later, if the funds are not received, to determine whether the transfers actually occurred, or not. These delays or lags and investigations are inefficient, time consuming and costly.

Uniquely, in connection with funding cross-border and/or cross-currency transactions, the systems and methods herein provide for liquidity in the regions of beneficiary institutions to the transactions, where sender institutions to the transactions are located in different regions. In particular, at the initiation of a fund transfer, a payment network receives funds for the transfer (e.g., at a sponsor institution, etc.), and then requests funds (e.g., consistent with a currency exchange quote, etc.) from a liquidity provider in a region of the beneficiary institution of the transfer. The funds are provided to the payment network, from the liquidity provider, at a sponsor institution, whereby the funds are then transferred to the beneficiary institution. The payment network records the debit and credit of the interaction (with the sponsor institution, a currency exchange provider, and the liquidity provider, etc.) to a repository (e.g., a blockchain data structure, etc.), and settles the transaction, as appropriate. In this manner, the systems and methods herein provide for a multi-region architecture that provides efficient and real time (or near real time) (e.g., immediately (e.g., within a few seconds, or minutes, etc.), etc.) cross-border transactions or transfers, whereby the sender institutions are not required to hold funds in the regions of the beneficiary institutions. What's more, the architecture implemented via the systems and methods herein may also provide for reduction in network traffic, as the transactions may be promptly recognized as successful, or not, whereby sender institutions are able to contemporaneously identify the corresponding fund transfers, as compared to requiring later in time investigations of (and corresponding cross-border communications relating to) the fund transfers by and between the sender institutions and the beneficiary institutions in the different regions.

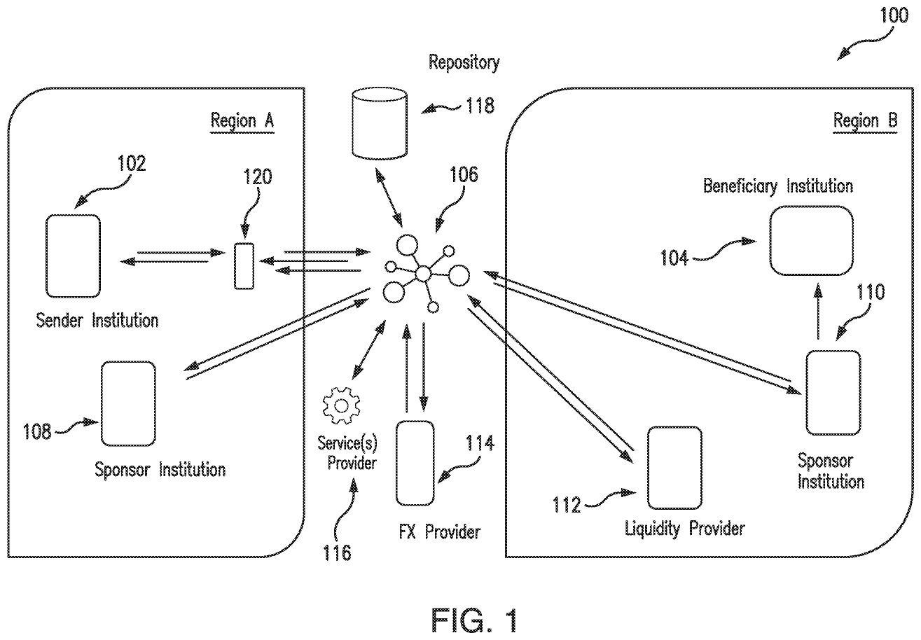

FIG. 1 illustrates an example system 100, in which one or more aspects of the present disclosure may be implemented. Although the system 100 is presented in one arrangement in FIG. 1, other embodiments may include systems arranged otherwise depending, for example, on a manner in which network messaging is initiated, specific transfer standards employed in the networks, users involved in the network messaging, regions involved in the interactions, privacy rules and regulations, etc.

In the illustrated embodiment, the system 100 generally includes a sender institution 102 (broadly, a first institution) and a beneficiary institution 104 (broadly, a second institution), and a payment network 106 coupled in communication therebetween. The system 100 also includes two sponsor institutions 108 and 110 and a liquidity provider 112. Each of the sponsor institutions 108 and 110 is associated with the payment network 106. In particular, in this example embodiment, each of the sponsor institutions 108 and 110 is configured to issue an account to the payment network 106, whereby funds associated with the description herein are deposited, held, and/or transferred as needed/appropriate to settle transactions, etc. Additionally, or alternatively, it should be appreciated that the accounts from the sponsor institutions 108 and 110 may not be issued to the payment network 106, but may be issued otherwise but still controlled and/or managed by the payment network 106.

Each of the sender institution 102, the beneficiary institution 104, the sponsor institutions 108 and 110, and the liquidity provider 112 is a banking institution (e.g., a bank, etc.) or financial institution in this example embodiment, which is configured to hold funds in separate accounts, in general or on behalf of users (or other institutions), and to transfer the funds as directed by the users (or other institutions), or in connection with transfers directed by users (or other institutions), etc. It should also be appreciated that the institutions 102, 104, 108, and 110 and/or provider 112 may be combined in one or more other system embodiments, whereby, for example, the sponsor institution 110 may also be the beneficiary institution 104. Other combinations of the institutions 102, 104, 108, and 110 and/or the provider 112, as appropriate, should be considered to be within the scope of the present disclosure. What's more, it should be appreciated that the institutions 102, 104, 108, and 110 and the provider 112 in the system 100 are each coupled to (and in communication with) one or more communication networks. The one or more communication networks are represented in FIG. 1 by the various arrowed lines and each may include, without limitation, a local area network (LAN), a wide area network (WAN) (e.g., the Internet, etc.), a mobile network, and/or another suitable public and/or private network capable of supporting communication among two or more of the parts illustrated in FIG. 1, or any combination thereof.

Also in the illustrated embodiment, the system 100 includes two regions: region A and region B. The regions A and B may be states, territories, countries, or other suitable divisions, etc. In general, the regions A and B are defined by laws, agreements, borders, or otherwise, etc., and are associated with different currencies. In this embodiment, a first currency is used in region A, and a second, different currency is used in region B. For example, region A may include the United States with a currency of U.S. dollars (USD), while region B may include the European Union with a currency of Euros (€). Consequently, then, a transaction between a user or entity in region A with a user or entity in region B is a cross-border (and cross-currency) transaction. Alternatively, region A and region B may represent two different countries within the European Union, whereby a transaction between a user or entity in region A with a user or entity in region B is a cross-border transaction (but not necessarily a cross-currency transaction). While the liquidity provider 112 is shown in region B in FIG. 1, it should be appreciated that the liquidity provider 112 may instead be located in region A as needed (e.g., to accommodate a flow of a transfer in the system 100 from region B to region A, etc.). In a similar way, it should also be appreciated that both region A and region B may include a liquidity provider consistent with liquidity provider 112 (as part of a same liquidity provider entity or as separate liquidity provider entities).

The system 100 also includes a foreign-exchange (FX) provider 114, which is configured to provide currency conversions between region A and region B (and other regions as included in various embodiments) for cross-currency transactions involving regions A and B. In addition, the system 100 includes a service(s) provider 116, which is configured to apply one or more services to a transaction performed between the regions A and B (and, more particularly, a transaction processed by or through the payment network 106). The one or more services may include, without limitation, compliance services, account services, validation services, etc.

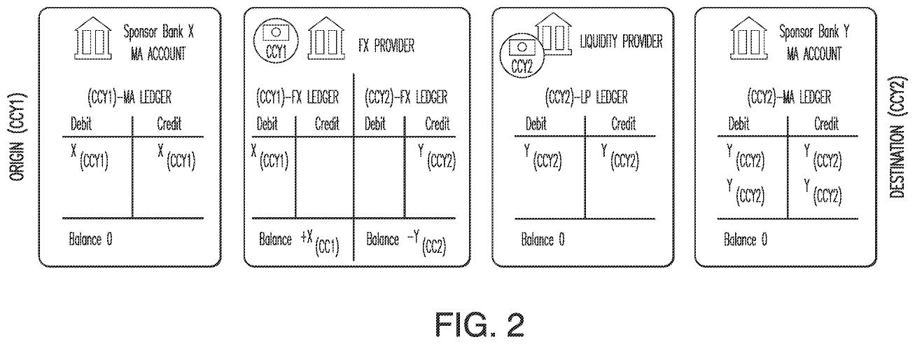

Further, the system 100 includes a data structure, or repository 118. The repository 118 may include any suitable type of ledger, including, for example, a distributed ledger data structure or a blockchain data structure, etc., whereby the ledger includes a continually growing list of ordered blocks or records or entries. Each record or entry includes a time stamp and a reference or link to a prior record or entry, and a cryptographic hash of the previous block, a timestamp, and content (e.g., fund credits or debits, etc.). Once a block (or record or entry) is recorded to the blockchain data structure, it may be considered immutable, as the block cannot be altered retroactively without alteration of all subsequent blocks, which requires consensus of a majority of the stakeholders in the data structure (e.g., the payment network 106, etc.). An example segment of data included in the repository 118 is shown in FIG. 2, as described more below.

It should be appreciated that, in some embodiments, the FX provider 114, the service(s) provider 116, and the repository 118 may be included, in whole or in part, in the payment network 106. Conversely, one of more of the FX provider 114, the service(s) provider 116, and the repository 118 may be separate and distinct from the payment network 106 (e.g., as part of one of the institutions 102, 104, 108, and 110; as part of the provider 112; etc.). Moreover, the payment network 106, the FX provider 114, the service(s) provider 116, and the repository 118, as shown in FIG. 1, are not illustrated as being specifically included within either region A or region B. As such, it should be understood that the payment network 106, the FX provider 114, the service(s) provider 116, and the repository 118 may be included in either or both of the regions A and B (and/or partially or entirely in a different region).

In this example embodiment, in connection with an interaction between a first entity (e.g., located in region A, etc.) and a second entity (e.g., located in region B, etc.), the sender institution 102 is configured to initiate a push transaction to transfer funds from an account of the first entity (at the sender institution 102) to an account of the second entity (at the beneficiary institution 104). In other examples, the transaction may be initiated in manners other than as a push transaction by the sender institution 102 (e.g., a pull transaction by the beneficiary institution 104, etc.).

In connection with the push transaction, for example, the interaction between the first and second entities may involve the first entity wanting to transfer the funds to satisfy an invoice with the second entity, or for another suitable reason, etc. In connection therewith, the sender institution 102 is configured to transmit a transaction request to a node 120 of the payment network 106 (as located, in this example, in region A). The node 120 may include, for example, an interface processor (e.g., a distributed ledger technology (DLT) node, a Mastercard interface processor or MIP, etc.) associated with the payment network 106 and/or located in region A at the sender institution 102, etc. The transaction request may include details of the underlying transaction between the first and second entities such as, for example, an amount of the transaction, a currency of the transaction (e.g., based on the location of the transaction in region A, etc.), etc.

In addition, in connection with initiating the push transaction, the sender institution 102 is configured to transfer funds to the sponsor institution 108, via a real time transfer between the two institutions 102 and 108 (e.g., via an appropriate domestic payment scheme for region A (e.g., IMPS or UPI in India, TCH in the United States, Faster Payments in UK, TIPS or SCT Inst. in Europe, FAST in Singapore, NPP in Australia, Faster Payment System (FPS) in China, etc.), etc.), into an account associated with and/or accessible to the payment network 106. In connection therewith, an amount associated with currency conversion required for the transaction will generally be based on an agreement between the sender institution 102 and the FX provider 114. While the sender institution 102 and the sponsor institution 108 are illustrated as separate entities in FIG. 1, it should be appreciated that the sender institution 102 and the sponsor institution 108 may be the same institution (or bank) in certain embodiments, whereby the transfer may be more efficient and may be on par with local scheme transfer service level agreements (SLAs).

When the transaction request for the push transaction is received at the payment network 106, via the node 120, the payment network 106 is configured, in turn, to request verification from the sponsor institution 108 that the sponsor institution 108 is in possession of funds for the transaction. In turn, the sponsor institution 108 is configured to notify (or verify to) the payment network 106 that the funds are in the possession of the sponsor institution 108 (e.g., at substantially the moment the funds are in possession of the sponsor institution 108, etc.). In response to the notification (or verification) by the sponsor institution 108, the payment network 106 is configured to notify the sender institution 102, via the node 120, of the funding being in possession of the sponsor institution 108. The payment network 106 is further configured to place a hold on the funds and to add a debit entry (broadly, an entry to a record) in USD, for example (as the currency of region A), to the repository 118 for (or on behalf of) the sponsor institution 108 (based on the interaction between the sender institution 102 and the sponsor institution 108).

FIG. 2 includes an example record of the repository 118, which may be used to illustrate the actions by the payment network 106 at the repository 118 in connection with the above example push transaction. In general, the example record of the repository 118 includes entries for a sponsor bank X (e.g., the sponsor institution 108, etc.), an FX provider (e.g., the FX provider 114, etc.), a liquidity provider (e.g., the liquidity provider 112, etc.), and a sponsor bank Y (e.g., the sponsor institution 110, etc.). In connection therewith, the entries involve a first currency, CCY1 (e.g., US dollars in the above example, etc.), and a second currency, CCY2 (e.g., Euros in the above example, etc.). In this example, then, as part of initiating the push transaction and placing a hold on funds transferred to the sponsor bank X (e.g., by the sender institution 102, etc.), the payment network 106 is configured to make a debit entry, of X_{(CCY1)} (i.e., the amount X transferred to the sponsor bank X in the CCY1 currency by the sender institution 102, etc.), with regard to a MA Account and MA Ledger (where X_{(CCY1)} is known to the payment network 106 from the transaction request, etc.).

With reference again to FIG. 1, also in response to the transaction request, the payment network 106 is configured to interact with the service(s) provider 116, as appropriate or necessary, based on the transaction, the sender institution 102, the beneficiary institution 104, the regions A and B, etc., to employ one or more services, etc. to the transaction. The service(s) provider 116 may aid the payment network 106 in determining whether the payment network 106 is able and permitted to facilitate the transaction, etc. For example, the service(s) provider 116 may be configured to screen the transaction for compliance with applicable regulations (e.g., anti-money laundering protocols, counter terrorist financing, fraud monitoring, etc.). In connection therewith, the service(s) provider 116 is configured to confirm completion of the one or more services to the payment network 106 (and a corresponding result thereof). Thereafter, the payment network 106 is configured to notify the sender institution 102, via the node 120, of the completion of the one or more services provided by the service(s) provider 116.

Next, in this example push transaction, the payment network 106 is configured to request a currency conversion quote from the FX provider 114. Upon receipt of the conversion quote request, the FX provider 114 is configured to provide a conversion quote for the amount of the transaction, which includes a settlement date and time and other suitable details (e.g., a conversion rate, the amount of the transaction in a different currency, etc.). For example, where the transaction request is for USD50, the FX provider 114 may provide a conversion quote of about 45 €. The payment network 106 is configured to interact with the FX provider 114 to accept the quote and lock in the conversion rate, settlement date and time, etc. And, the payment network 106 is configured to add an entry to the repository 118 for the conversion, as a debit in USD (the currency of region A) and a credit in Euros (the currency of region B), and also a debit in Euros for the sponsor institution 110. The payment network 106 is also configured to confirm the conversion, and rate, etc., to the sender institution 102, via the node 120, etc.

With reference to the example record of the repository 118 shown in FIG. 2, in connection with such interaction with the FX provider 114, the payment network 106 may make a debit entry in the record in the repository 118, for the FX provider, of X_{(CCY1)} under the CCY1 FX ledger. And, the payment network 106 may then make a credit entry for the FX provider of Y_{(CCY2)} (i.e., the amount Y in the CCY2 currency based on the conversion of the amount X from the CCY1 currency to the CCY2) under the CCY2 FX Ledger. Additionally, an entry is included in the record, for the sponsor bank Y, with regard to the MA account and MA Ledger, as a debit of Y_{(CCY2)} (the upper Y_{(CCY2)} in FIG. 2), which is known by the payment network 106 based on the FX quote.

Further, in the example push transaction, the payment network 106 is configured to request liquidity from the liquidity provider 112. In response, the liquidity provider 112 is configured to provide a quote for the funds (in the currency of region B, or Euros), and the payment network 106 is configured to interact with the liquidity provider 112 to accept the quote and lock the terms, etc. The liquidity provider 112 is configured to transfer funds to the sponsor institution 110, via the payment network 106 (or otherwise, for example, via an appropriate domestic payment scheme for region B, etc.), via a real time transfer. In connection therewith, the payment network 106 is configured to again add entries to the repository 118, which include a credit to the liquidity provider 112 in Euros and a debit for the sponsor institution 110 in Euros. As shown in FIG. 2, for instance, when the liquidity is provided, the payment network 106 is configured to add a credit entry to the record in the repository 118, for the liquidity provider, of Y_{(CCY2)}, to the LP Ledger. The payment network 106 is also configured to add another entry in the example record of FIG. 2, for the sponsor bank Y, as a debit of Y_{(CCY2)} (the lower Y_{(CCY2)} in FIG. 2).

Thereafter, the sponsor institution 110 is configured to transfer the funds to the beneficiary institution 104 and to confirm to the payment network 106 that the funds have been paid to the beneficiary institution 104. The payment network 106, in turn, is configured to notify the sender institution 102 of the successful transfer. In this manner, the sender institution 102 is permitted to understand the transfer is indeed complete (and not merely directed).

Later, at the settlement date and time included in the FX quote (or otherwise), the payment network 106 is configured to remove the hold on the funds in the various accounts, and coordinate settlement. In particular, the payment network 106 is configured to transfer funds to the FX provider 114, from the account at the sponsor institution 108 in region A, and the FX provider 114 is configured to transfer funds to the liquidity provider 112, thereby settling the obligation to the liquidity provider 112, in region B, on behalf of the payment network 106 for the liquidity provided. All balances in the repository 118 for the transaction return to zero, except for the FX provider 114, as appropriate. It should be appreciated that in connection with the above, the payment network 106 is configured to add entries to the repository 118 to show each of the obligations and liabilities amongst the entities in system 100 to the repository 118 (e.g., in a backend ledger, etc.). That said, it should be appreciated that the use of an FX swap herein may allow for reduction in steps/processes required to effect the transfer described above, whereby various benefits of the system 100 described herein may be realized.

With reference to the example in FIG. 2, in connection with settling the transfer, additional entries are added to the record by the payment network 106 as credits (for the sponsor bank X and the sponsor bank Y) and debits (for the liquidity provider), indicative of the above transfer. As a result, the balances in the ledger are zero for each of the sponsor bank X, the liquidity provider, and the sponsor bank Y. The balance for the FX provider is not zero, which is correct as the FX provider 114 is in receipt of a debit and a credit consistent with the FX quote from above in the different currencies. Consequently, the repository 118 provides a complete record of the transfer (e.g., as a substantially immutable record when the repository 118 includes a blockchain data structure, etc.).

In connection therewith, the transfer is completed from the sender institution 102, to the beneficiary institution 104, via the on-demand liquidity provided by the liquidity provider 112, whereby the sender institution 102 is thereby not required to separately hold funds in region B to provide for the cross-border transaction into region B.

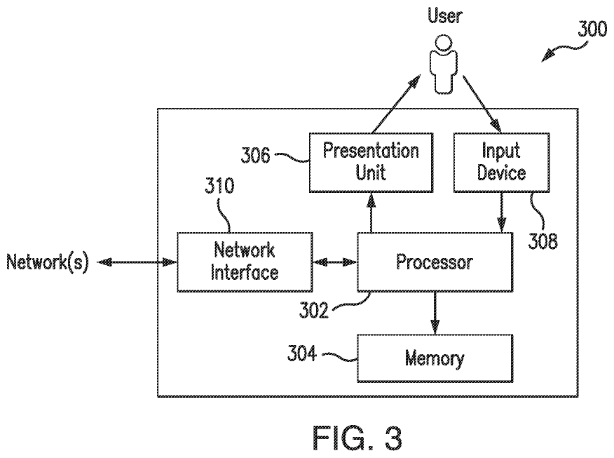

FIG. 3 illustrates an example computing device 300 that can be used in the system 100. The computing device 300 may include, for example, one or more servers, workstations, personal computers, POS terminals, laptops, tablets, smartphones, PDAs, virtual devices, etc. In addition, the computing device 300 may include a single computing device, or it may include multiple computing devices located in close proximity or distributed over a geographic region as a network of computing devices, so long as the computing devices are specifically configured to function as described herein. In particular, in the example system 100 of FIG. 1, each of the institutions 102, 104, 108, and 110, the payment network 106, the providers 112, 114, and 116, and the repository 118 should be understood as being implemented in (and/or otherwise including) one or more computing devices generally consistent with the computing device 300. That said, the system 100 should not be considered to be limited to the computing device 300, as described below, as different computing devices and/or arrangements of computing devices may be used in other embodiments. In addition, different components and/or arrangements of components may be used in other computing devices.

Referring to FIG. 3, the example computing device 300 includes a processor 302 and a memory 304 coupled to (and in communication with) the processor 302. The processor 302 may include one or more processing units (e.g., in a multi-core configuration, etc.). For example, the processor 302 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 304, as described herein, is one or more devices that permit data, instructions, etc., to be stored therein and retrieved therefrom. The memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 304 may be configured to store, without limitation, transaction data, message format translation details, instructions for messaging in particular standards, ledgers, debit and credit data entries, and/or other types of data (and/or data structures) suitable for use as described herein.

Furthermore, in various embodiments, executable instructions may be stored in the memory 304 for execution by the processor 302 to cause the processor 302 to perform one or more of the operations described herein (e.g., one or more of the operations described in method 400, one or more of the operations described in method 600, etc.), such that the memory 304 is a physical, tangible, and non-transitory computer readable storage media. Such instructions often improve the efficiencies and/or performance of the processor 302 that is performing one or more of the various operations herein, whereby the instructions (when performed by the processor 302) effectively transform the computing device 300 into a special purpose device configured to perform the unique and specific operations described herein. It should be appreciated that the memory 304 may include a variety of different memories, each implemented in one or more of the functions or processes described herein.

In addition in the example embodiment, the computing device 300 includes a presentation unit 306 that is coupled to (and is in communication with) the processor 302 (however, it should be appreciated that the computing device 300 could include output devices other than the presentation unit 306, etc.). The presentation unit 306 outputs information (e.g., a notification associated with a transfer, etc.), either visually or audibly, to a user of the computing device 300, etc. And, various interfaces (e.g., as defined by applications, webpages, etc.) may be displayed at computing device 300, and in particular at presentation unit 306, to display such information. The presentation unit 306 may include, without limitation, a liquid crystal display (LCD), a light-emitting diode (LED) display, an organic LED (OLED) display, an “electronic ink” display, speakers, etc. In some embodiments, presentation unit 306 may include multiple devices.

The computing device 300 also includes an input device 308 that receives inputs from the user of the device (i.e., user inputs) such as, for example, transfer request, etc. The input device 308 is coupled to (and is in communication with) the processor 302 and may include, for example, a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 306 and the input device 308.

In addition, the illustrated computing device 300 also includes a network interface 310 coupled to (and in communication with) the processor 302 and the memory 304. The network interface 310 may include, without limitation, a wired network adapter, a wireless network adapter, a mobile network adapter, or other device capable of communicating to/with one or more different networks, including one or more of the networks in FIG. 1. Further, in some example embodiments, the computing device 300 may include the processor 302 and one or more network interfaces (including the network interface 310) incorporated into or with the processor 302.

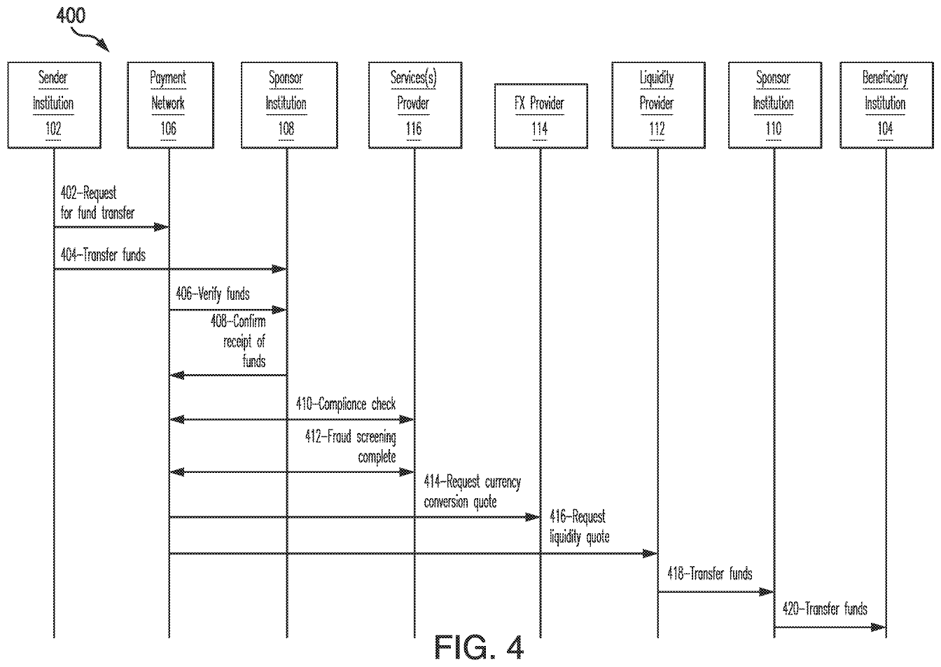

FIG. 4 illustrates an example method 400 for use in facilitating a cross-border, or cross-currency, transaction. While the method 400 is generally consistent with the above description of the operation of the system 100, as including the computing device 300, it should be appreciated that the methods herein are not limited to the system 100, or computing device 300. And, likewise, the systems and computing devices described herein are not limited to the example method 400.

In general in the method 400, a first entity desires to transfer funds (via the sender institution 102) to a second entity (and by way of the beneficiary institution 104), for example, to satisfy an invoice with the second entity, or for another suitable reason, etc. In connection therewith, as generally described above in the system 100, the sender institution 102 (e.g., based on its interaction with the first entity to transfer the funds, etc.) transmits a transaction request for the fund transfer to a node 120 (e.g., an interface processor, etc.) of the payment network 106 (as located, in this example, in region A in FIG. 1). And, the payment network receives the request, at 402. In connection therewith, the sender institution 102 also transfers, at 404, funds for the transfer to the sponsor institution 108.

In response to the transaction request, the payment network 106 verifies, at 406, with the sponsor institution 108, that the sponsor institution 108 is in possession of funds for the fund transfer (from the sender institution 102, for example, as transferred via the Faster Payment System (FPS), etc.). In turn, the sponsor institution 108 notifies, at 408, the payment network 106, that the funds are in the possession of the sponsor institution 108. In response to the funds being present at the sponsor institution 108, the payment network 106 notifies the sender institution 102, via the node 120, of such. The payment network 106 then places a hold on the funds at the sponsor institution 108 and adds a debit entry to the repository 118 for (or on behalf of) the sponsor institution 108.

Also in response to the transaction request, the payment network 106 interacts with the service(s) provider 116, as appropriate or necessary, at 410 and 412, to employ one or more services, etc. to the fund transfer. The service(s) provider 116 may aid the payment network 106 in determining whether the payment network 106 is able and permitted to facilitate the fund transfer, etc. For example, in the illustrated method 400, the service(s) provider 116 screens the fund transfer for compliance with applicable regulations (at 406), including, for example, anti-money laundering protocols, and counter terrorist financing, and further performs fraud monitoring on the fund transfer (at 408). In connection therewith, the service(s) provider 116 confirms completion of the services to the payment network 106 (and a corresponding result thereof). Thereafter, the payment network 106 notifies the sender institution 102, via the node 120, of the completion of the services provided by the service(s) provider 116.

Next in the method 400, the payment network 106 requests, at 414, a currency conversion quote from the FX provider 114. Upon receipt, the FX provider 114 provides a conversion quote for the amount of the fund transfer, which includes a settlement date and time and other suitable details (e.g., a conversion rate, etc.). The payment network 106 then interacts with the FX provider 114 to accept the quote and lock in the conversion rate, settlement date and time, etc. And, the payment network 106 adds an entry to the repository 118 for the conversion. The payment network 106 also confirms the conversion, and rate, etc., to the sender institution 102, via the node 120, etc.

Further, the payment network 106 requests, at 416, a liquidity quote (or quotes) from the liquidity provider 112 for the fund transfer. In response, the liquidity provider 112 provides a quote for the funds (in the currency of the region of the sender institution), and the payment network 106 interacts with the liquidity provider 112 to accept the quote and lock the terms, etc. The liquidity provider 112 then transfers, at 418, funds to the sponsor institution 110, via the payment network 106 (or otherwise, for example, via an appropriate domestic payment scheme, etc.), via a real time transfer. In connection therewith, the payment network 106 again adds entries to the repository 118, with regard to the provided liquidity and transferred funds.

Thereafter, the sponsor institution 110 transfers, at 420, the funds to the beneficiary institution 104 (on behalf of the second entity) and confirms to the payment network 106 that the funds have been paid to the beneficiary institution 104. The payment network 106, in turn, notifies the sender institution 102 of the successful transfer. In this manner, the sender institution 102 is permitted to understand the transfer is indeed complete (and not merely directed). Later, at the settlement date and time included in the FX quote (or otherwise), the payment network 106 removes the hold on the funds in the various accounts, and coordinates settlement between the FX provider 114, the sponsor institution 108, the sponsor institution 110, and the liquidity provider 112.

It should be understood that fees (or commissions) associated with the example method 400 may be distributed to either or both of the sponsor institutions 108 and 110 and/or to either or both of the sender and beneficiary institutions 102 and 104 and/or to the payment network 106, which may be associated with a revenue share splitting as defined by any of the involved entities (e.g., the payment network 106, the sponsor institution 108, etc.).

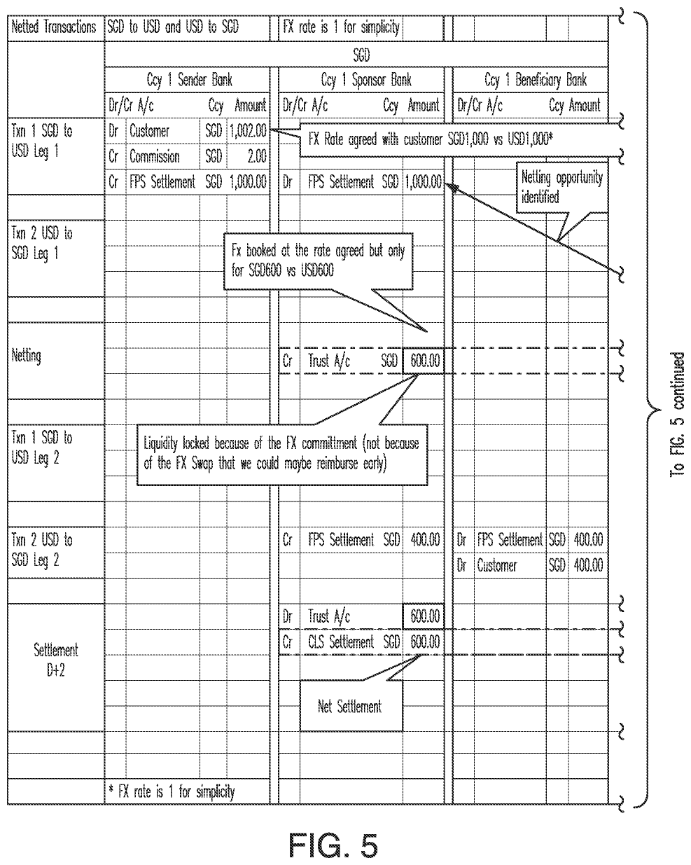

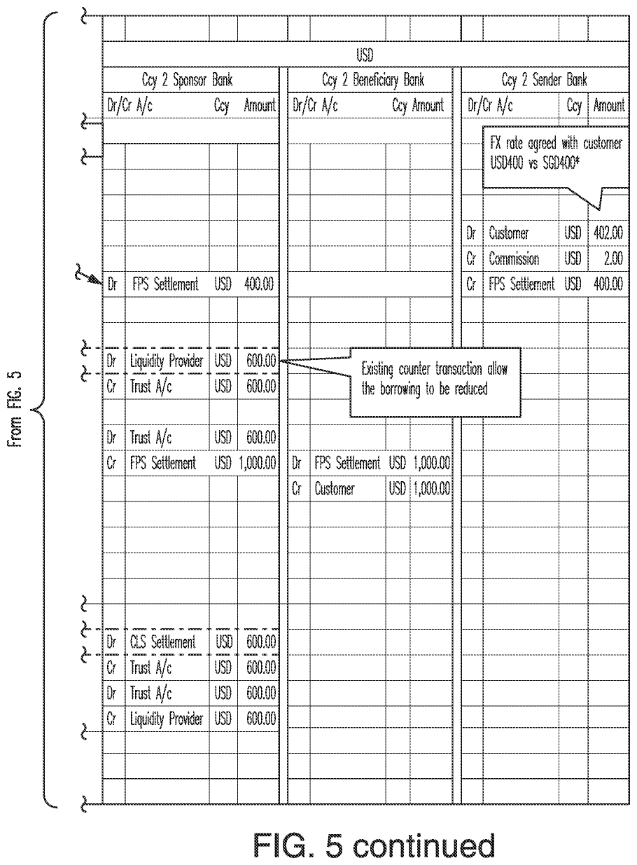

FIG. 5 illustrates example entries in a ledger that may be generated in connection with a transfer across currencies involving a Singapore dollar (SGD) and a US dollar (USD), and in which a commission is provided, consistent with the implementation of the system 100 and/or the method 400.

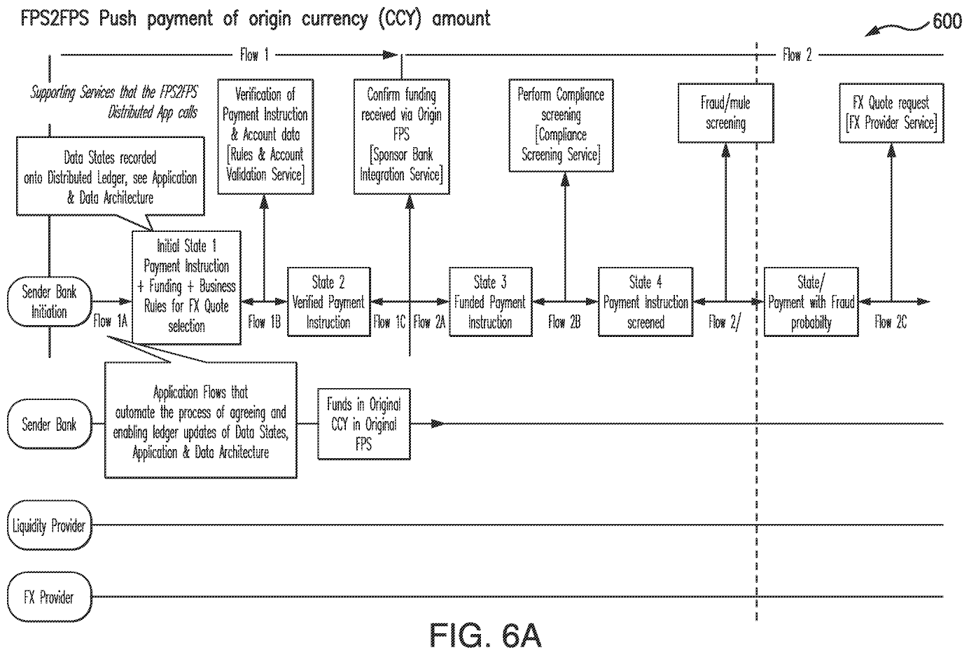

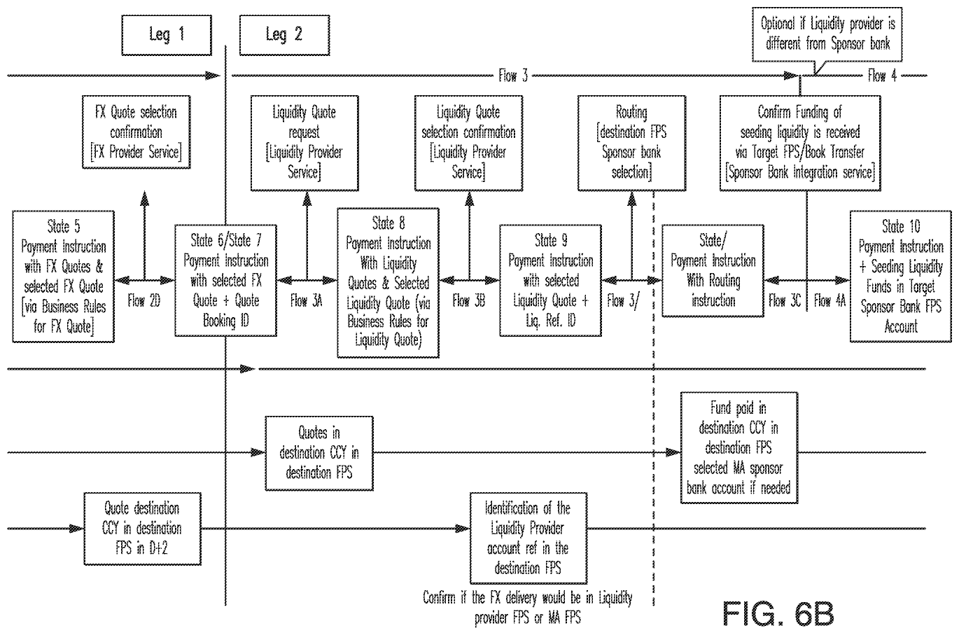

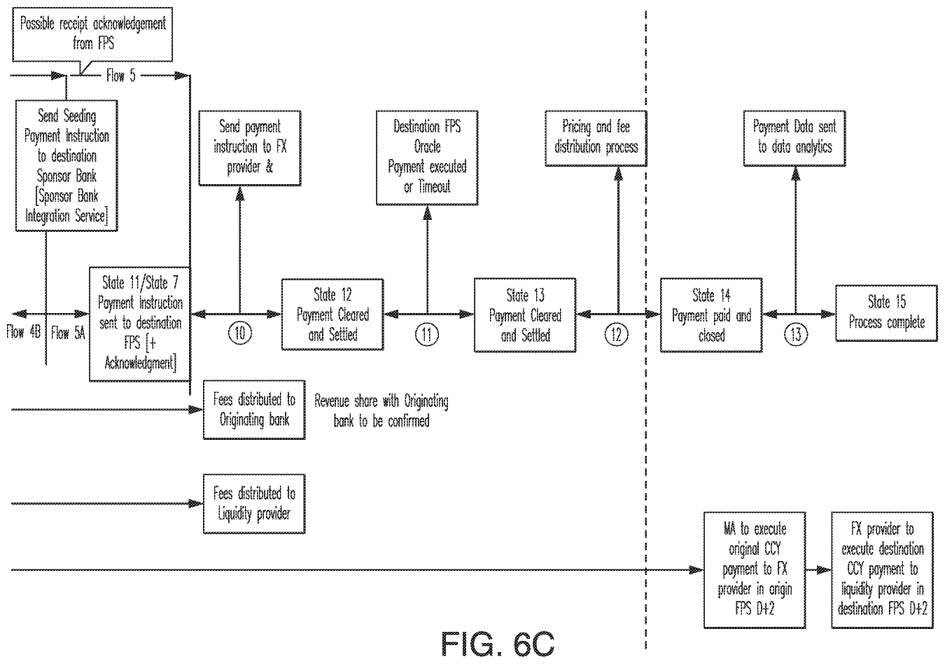

FIGS. 6A-6C illustrate another example method 600 for use in conducting a cross-border transaction (e.g., a push payment, etc.), as recorded to a data structure. The method 600 is generally consistent with the above description of the operation of the system 100, as including the computing device 300, and the description of the operations of method 400. In connection therewith, the descriptions above also generally apply the flow of the method 600. However, it should be appreciated that the methods herein are not limited to the system 100, or computing device 300, or method 400, or method 600.

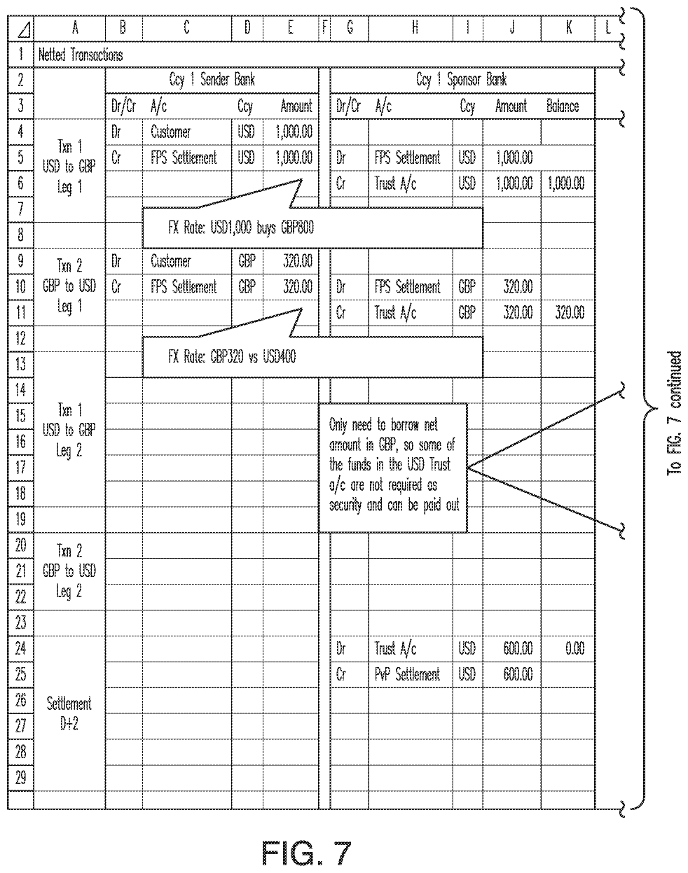

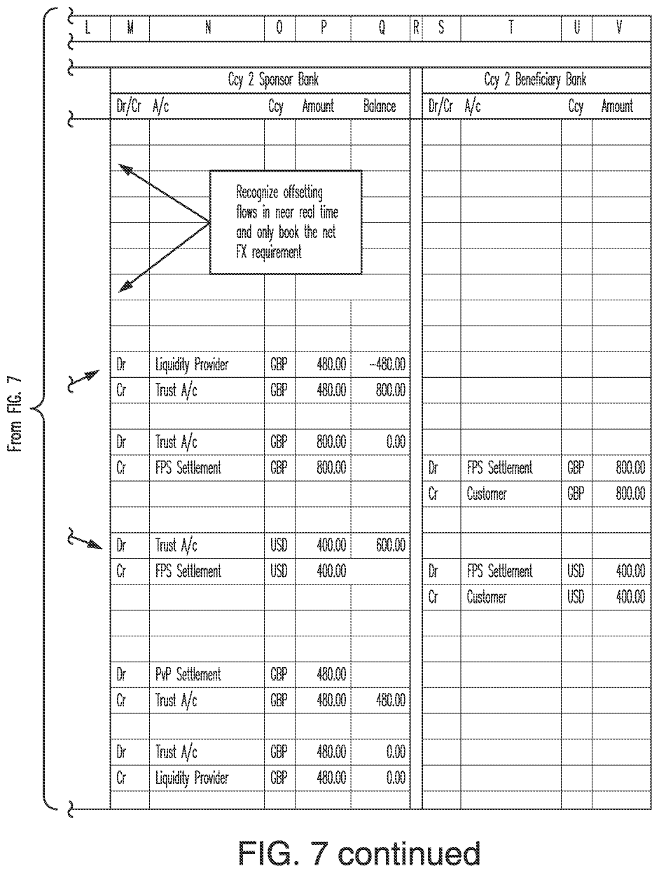

FIG. 7 illustrates example entries in another ledger, for two transactions (txns) that may be made at similar times. Each transaction is a cross-border, cross-currency transaction and invokes instant payment via the system 100 and/or the method 400. The first transaction involves a US dollar (USD) to Great British pound (GBP) payment. And, the second transaction involves a GBP to USD payment. That said, it should be appreciated that the system 100 and/or method 400, and in particular, the payment network 106, is suited to deal with more than two currencies. In FIG. 7, for transaction 1, the Currency 1 (Ccy1) Sender Bank is a US bank; and for transaction 2, the Ccy1 Sender Bank is a UK bank. As such, the values under the heading “Ccy1 Sender Bank”, in columns B to E, for the two transactions, refer to different banks performing transactions.

In connection therewith, when the end customer (the remitter in banking terminology) instructs their bank (the Ccy1 Sender Bank) to make the payment, the bank debits (Dr) their account USD1,000 and pays that via the local Faster Payment to the Ccy1 sponsor bank. It should be appreciated, in the context of FIG. 7, that a debit and credit, one below the other, form a standard double-entry accounting record, while a credit and a debit on the same row represent a payment from one bank to another. At about the same time (in near real time (e.g., within a few seconds, within a minute, or within five minutes, etc.)) the customer instructs the Ccy1 Sender Bank to make the payment, transaction 2 is initiated to make a payment that is going the other way, whereby GBP320 is exchanged for USD400 exactly.

It should be appreciated that, for the sake of simplicity, this example assumes the exchange rate on the two payments is exactly the same. However, in reality, there will likely be a spread between the rates (such that if USD1,000 were exchanged for GBP and then immediately exchanged back, the exchange back would be for more or less than USD1,000). That said, the payment network 106 recognizes the offsetting nature of the transactions, and only books a single foreign exchange trade for the net amount, in this case USD600 to GBP480 (as an aggregation of the two transactions), thus providing savings in the amount of associated overhead costs.

Then in this example, the payment network 106 coordinates fund raising from the liquidity provider 112 and makes the payment to the beneficiary institution 104, consistent with the above. As a result, by further aggregating transactions, for example, in connection with the exchange, it is clear that the architecture provided by the systems and methods herein may provide for less currency exchanges (and thus, further, less network traffic) and less liquidity required (which may even provide offsetting costs for the transactions, etc.). In connection with the above, based on the single foreign exchange trade in this example, settlement of the FX trade may involve a single settlement that takes place based on the aggregated amount. Similarly, repaying of the liquidity provided as part of the transactions may be based on the aggregated amount. However, settlement for each particular transaction may take place separately by way of the individual, particular institutions involved in the given transaction.

In view of the above, the systems and methods herein may provide efficient and real time (or near real time) (e.g., immediately (e.g., within a few second, or minutes, etc.), etc.) cross-border transactions or transfers, whereby sender institutions are not required to hold funds in regions of beneficiary institutions nor maintain, for example, Nostro/Vostro accounts at correspondent banks. In connection therewith, the systems and methods herein may facilitate completion of cross-border transactions within minutes or seconds, on a generally continuous basis (e.g., twenty-four hours a day, seven days a week; etc.), on behalf of sending institutions, without the sending institution needing to hold, or have pre-arranged access to, funds in a destination currency. What's more, the systems and methods herein may provide for reductions in investigations associated with fund transfers because the funds are transferred promptly within seconds or minutes, etc. As such, there is no substantial interval between an initiation of a transfer and settlement of the transfer, whereby the entities involved are able to readily confirm the transfer (or recognize an issue), thereby foregoing later in time investigations related to whether or not a specific fund transfer was completed.

Moreover, the systems and methods herein may further provide for efficiencies in connection with required relationships between different institutions and/or providers. In the above description, the sender institution is able to maintain a relationship with the network, but does not necessarily have a relationship with the FX provider, the liquidity provider and/or the sponsor institution (and indeed may not even know which institutions and/or providers are involved in the transaction). This may provide for efficient operations of the sender institution, as are related to the network, and not require the sender institution to maintain separate relationships with the four or more other entities in the system 100, for example. In other examples, though, the sender institution may still have or may still maintain a relationship with the FX provider.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims and/or otherwise recited herein.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and “at least one of” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating network messaging, the method comprising:
receiving, by a computing device, a request to transfer funds, in a first currency, from a first institution in a first region to a second institution in a second region;
verifying, by the computing device, the funds as being in possession of a sponsor institution in the first region;
requesting, by the computing device, a conversion quote from an FX provider for the funds;
receiving, by the computing device, the conversion quote from the FX provider, the conversion quote including the funds in a second currency;
adding, by the computing device, an entry for the funds in the second currency to a ledger in association with the FX provider and in association with a sponsor institution in the second region;
requesting, by the computing device, from a liquidity provider in the second region, a liquidity quote for the funds in the second currency;
accepting, by the computing device, the liquidity quote from the liquidity provider, whereby the funds in the second currency are transferred, in the second region, from the liquidity provider to the sponsor institution in the second region and then to the second institution; and
facilitating, by the computing device, settlement between the sponsor institution in the first region and the FX provider, and between the FX provider and the sponsor institution in the second region.

2. The computer-implemented method of claim 1, further comprising performing one or more services, for the transfer, prior to requesting the conversion quote.

3. The computer-implemented method of claim 1, wherein the ledger includes a blockchain data structure.

4. The computer-implemented method of claim 1, further comprising:
adding, by the computing device, an entry for the funds in the first currency to the ledger in association with the sponsor institution in the first region;
adding, by the computing device, an entry for the funds in the first currency to the ledger in association with the FX provider; and
adding, by the computing device, an entry for the funds in the second currency to a ledger in association with the liquidity provider.

5. The computer-implemented method of claim 1, further comprising:
notifying, by the computing device, the first institution of the conversion quote;
notifying, by the computing device, the first institution of the transfer of the funds in the second currency from the sponsor institution in the second region to the second institution.

6. The computer-implemented method of claim 1, wherein the request is a first request, and wherein the method further comprises:
receiving, by the computing device, at about the same time as the request, a second request to transfer funds, in the second currency, from the second institution in the second region to the first institution in the first region;
requesting, by the computing device, a second conversion quote from an FX provider for the funds of the second request;
receiving, by the computing device, the second conversion quote from the FX provider, the second conversion quote including the funds of the second request in the first currency; and
aggregating the funds of the request in the first currency and the funds of the second request in the first currency, and aggregating the funds of the request in the second currency and the funds of the second request in the second currency;
wherein facilitating, by the computing device, settlement includes facilitating settlement based on the aggregation of the funds in the first currency and the aggregation of the funds in the second currency.

7. A non-transitory computer readable storage medium including executable instructions for use in network messaging, which when executed by at least one processor, cause the at least one processor to:
receive a request to transfer funds, in a first currency, from a sender institution in a first region to a beneficiary institution in a second region;
verify the funds as being in possession of a sponsor institution in the first region;
request a conversion quote from an FX provider for the funds in the first currency;
receive the conversion quote from the FX provider, the conversion quote including the funds in a second currency;
add an entry for the funds in the second currency to a ledger in association with the FX provider and in association with a sponsor institution in the second region;
request from a liquidity provider in the second region, a liquidity quote for the funds in the second currency;
accept the liquidity quote from the liquidity provider, whereby the funds in the second currency are transferred, in the second region, from the liquidity provider to the sponsor institution in the second region and then to the beneficiary institution; and
facilitate settlement between the sponsor institution in the first region and the FX provider, and between the FX provider and the sponsor institution in the second region.

8. The non-transitory computer readable storage medium of claim 7, wherein the ledger includes a blockchain data structure.

9. The non-transitory computer readable storage medium of claim 7, wherein the executable instructions, when executed by the at least one processor, further cause the at least one processor to:
add an entry for the funds in the first currency to the ledger in association with the sponsor institution in the first region;
add an entry for the funds in the first currency to the ledger in association with the FX provider; and
add an entry for the funds in the second currency to a ledger in association with the liquidity provider.

10. The non-transitory computer readable storage medium of claim 9, wherein the executable instructions, when executed by the at least one processor, further cause the at least one processor to:
notify the sender institution of the conversion quote;
notify the sender institution of the liquidity quote; and
notify the sender institution of the transfer of the funds in the second currency from the sponsor institution in the second region to the beneficiary institution.

11. The non-transitory computer readable storage medium of claim 7, wherein the executable instructions, when executed by the at least one processor, further cause the at least one processor to coordinate performance of one or more services, for the transfer, prior to requesting the conversion quote.

12. A system for use in facilitating network messaging, the system comprising:
at least one computing device configured to:
receive a request to transfer funds, in a first currency, from a sender institution in a first region to a beneficiary institution in a second region;
verify the funds as being in possession of a sponsor institution in the first region;
request a conversion quote from an FX provider for the funds in the first currency;
receive the conversion quote from the FX provider, the conversion quote including the funds in a second currency;
add an entry for the funds in the second currency to a ledger in association with the FX provider and in association with a sponsor institution in the second region;
request from a liquidity provider in the second region, a liquidity quote for the funds in the second currency;
accept the liquidity quote from the liquidity provider, whereby the funds in the second currency are transferred, in the second region, from the liquidity provider to the sponsor institution in the second region and then to the beneficiary institution; and
facilitate settlement between the sponsor institution in the first region and the FX provider, and between the FX provider and the sponsor institution in the second region.

13. The system of claim 12, wherein the ledger includes a blockchain data structure.

14. The system of claim 12, wherein the at least one computing device is further configured to:
add an entry for the funds in the first currency to the ledger in association with the sponsor institution in the first region;
add an entry for the funds in the first currency to the ledger in association with the FX provider; and
add an entry for the funds in the second currency to a ledger in association with the liquidity provider.

15. The system of claim 14, wherein the at least one computing device is further configured to:
notify the sender institution of the conversion quote;
notify the sender institution of the liquidity quote; and
notify the sender institution of the transfer of the funds in the second currency from the sponsor institution in the second region to the beneficiary institution.

16. The system of claim 12, wherein the at least one computing device is further configured to coordinate performance of one or more services, for the transfer, prior to requesting the conversion quote.
